(19) United States
(12) Patent Application Publication
(10) Pub. No.: US 2026/0067093 A1
(43) Pub. Date: Mar. 5, 2026

(54) METHOD OF FILTERING CONFIDENTIAL DATA AND ELECTRONIC DEVICE

(71) Applicant: Samsung Electronics Co., Ltd., Suwon-si (KR)

(72) Inventors: Sangwoo JI, Suwon-si (KR); Woochul SHIM, Suwon-si (KR); Hayoon YI, Suwon-si (KR)

(21) Appl. No.: 19/310,229

(22) Filed: Aug. 26, 2025

Related U.S. Application Data
(63) Continuation of application No. PCT/KR2025/012672, filed on Aug. 21, 2025.

(30) Foreign Application Priority Data
Aug. 28, 2024 (KR) 10-2024-0115966

(51) Int. Cl. H04L 9/32; G06F 21/62

(52) U.S. Cl. CPC H04L 9/3236; G06F 21/6245

(57) ABSTRACT

An electronic device is provided. The electronic device includes memory, including one or more storage media, storing instructions, and one or more processors communicatively coupled to the memory, wherein the instructions, when executed by the one or more processors individually or collectively, cause the electronic device to identify input data, which can be arranged in multiple lines, stored in the memory, generate a first feature vector by encoding, using an encoder, first part data corresponding to a first number of first lines among the input data, generate a second feature vector by encoding, using the encoder, second part data corresponding to the first number of second lines, the second lines at least partially overlapping the first lines, among the input data, and train the encoder such that a result of decoding the first feature vector and the second feature vector by a decoder corresponding to the encoder corresponds to the input data.

### CROSS-REFERENCE TO RELATED APPLICATION(S)

This application is a continuation application, claiming priority under 35 U.S.C. § 365 (c), of an International application No. PCT/KR2025/012672, filed on Aug. 21, 2025, which is based on and claims the benefit of a Korean patent application number 10-2024-0115966, filed on Aug. 28, 2024, in the Korean Intellectual Property Office, the disclosure of which is incorporated by reference herein in its entirety.

### TECHNICAL FIELD

The disclosure relates to a method for filtering secure data and an electronic device therefor.

### BACKGROUND ART

In line with remarkable development of information communication technology and semiconductor technology, use of various kinds of electronic devices has been widespread at an accelerating pace. Electronic devices have been developed such that uses can carry and use them for communication. Electronic devices may refer to devices configured to perform specific functions according to programs installed therein, such as mobile communication terminals, tablet personal computers (PCs), video/audio devices, desktop/laptop computers, or automotive navigation systems. However, electronic devices are not limited thereto, and may also refer to servers configured to store data.

Generative artificial intelligence (AI) has recently been increasingly used, and security problems may be caused by leakage of information input to programs that provide generative AI. For example, in case that program codes are composed or modified through generative AI, information that is input in the prompt (for example, confidential codes included in programs) may be included, and this may cause a confidentiality breach problem.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide a method and an electronic device, wherein information that is input in the prompt is locality-sensitive-hashed and is compared with hash values corresponding to secure data, thereby identifying whether secure information is included therein or not.

Additional aspects will be set forth in part in the description which follows and, in part, will be apparent from the description, or may be learned by practice of the presented embodiments.

In accordance with an aspect of the disclosure, an electronic device is provided. The electronic device includes memory, including one or more storage media, storing instructions, and one or more processors communicatively coupled to the memory, wherein the instructions, when executed by the one or more processors individually or collectively, cause the electronic device to identify input data, which can be arranged in multiple lines, stored in the memory, generate a first feature vector by encoding, using an encoder, first part data corresponding to a first number of first lines among the input data, generate a second feature vector by encoding, using the encoder, second part data corresponding to the first number of second lines, the second lines at least partially overlapping the first lines, among the input data, and train the encoder such that a result of decoding the first feature vector and the second feature vector by a decoder corresponding to the encoder corresponds to the input data.

In accordance with another aspect of the disclosure, an electronic device is provided. The electronic device includes memory, including one or more storage media, storing instructions and one or more processors communicatively coupled to the memory, wherein the instructions, when executed by the one or more processors individually or collectively, cause the electronic device to identify secure data which can be arranged in multiple lines, generate feature vectors by encoding the secure data by a trained encoder, generate multiple first hash values by performing a locality-sensitive-hashing (LSH) operation on a first feature vector corresponding to a first part having a first length among the feature vectors, based on multiple first configuration values, generate multiple second hash values by performing the LSH operation on a second feature vector corresponding to a second part having the first length, the second part at least partially overlapping the first part, among the feature vectors, based on multiple second configuration values, and store the multiple first hash values and the multiple second hash values in the memory.

In accordance with another aspect of the disclosure, an electronic device is provided. The electronic device includes memory, including one or more storage media, storing instructions, and one or more processors communicatively coupled to the memory, wherein the instructions, when executed by the one or more processors individually or collectively, cause the electronic device to identify input data which can be arranged in multiple lines, generate feature vectors by encoding the input data by a trained encoder, generate multiple first hash values by performing a locality-sensitive-hashing (LSH) operation on a first feature vector corresponding to a first part having a first length among the feature vectors, based on multiple first configuration values, generate multiple second hash values by performing the LSH operation on a second feature vector corresponding to a second part having the first length, the second part at least partially overlapping the first part, among the feature vectors, based on multiple second configuration values, and identify whether the input data includes secure data or not by comparing the multiple first hash values and the multiple second hash values with multiple hash values corresponding to the secure data stored in the memory.

In accordance with another aspect of the disclosure, a method for filtering secure data is provided. The method includes identifying input data which can be arranged in multiple lines, generating feature vectors by encoding the input data by a trained encoder, generating multiple first hash values by performing a locality-sensitive-hashing (LSH) operation on a first feature vector corresponding to a first part having a first length among the feature vectors, based on multiple first configuration values, generating multiple second hash values by performing the LSH operation on a second feature vector corresponding to a second part having the first length, the second part at least partially overlapping the first part, among the feature vectors, based on multiple second configuration values, and identifying whether the input data includes secure data or not by comparing the multiple first hash values and the multiple second hash values with multiple hash values corresponding to the secure data.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying input data which can be arranged in multiple lines, generating feature vectors by encoding the input data by a trained encoder, generating multiple first hash values by performing a locality-sensitive-hashing (LSH) operation on a first feature vector corresponding to a first part having a first length among the feature vectors, based on multiple first configuration values, generating multiple second hash values by performing the LSH operation on a second feature vector corresponding to a second part having the first length, the second part at least partially overlapping the first part, among the feature vectors, based on multiple second configuration values, and identifying whether the input data comprises secure data or not by comparing the multiple first hash values and the multiple second hash values with multiple hash values corresponding to the secure data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 schematically illustrates a network environment according to an embodiment of the disclosure;

FIG. 2 is a block diagram of an electronic device according to an embodiment of the disclosure;

FIG. 3 is a block diagram illustrating an AI model structure for encoder training according to an embodiment of the disclosure;

FIG. 4 is a block diagram illustrating a procedure of encoding secure data by an AI model according to an embodiment of the disclosure;

FIG. 5 is a block diagram illustrating a prompt input example according to an embodiment of the disclosure;

FIG. 6 is a block diagram illustrating a procedure of detecting secure data with regard to input data according to an embodiment of the disclosure;

FIG. 7 is a block diagram illustrating a procedure of detecting secure data with regard to input data according to an embodiment of the disclosure;

FIG. 8 is a flowchart illustrating a method for training an encoder according to an embodiment of the disclosure;

FIG. 9 is a flowchart illustrating a method for generating a database of secure data according to an embodiment of the disclosure;

FIG. 10 is a flowchart illustrating a method for detecting secure data with regard to input data according to an embodiment of the disclosure; and

FIG. 11 is a block diagram of an electronic device in a network environment according to an embodiment of the disclosure.

Throughout the drawings, it should be noted that like reference numbers are used to depict the same or similar elements, features, and structures.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

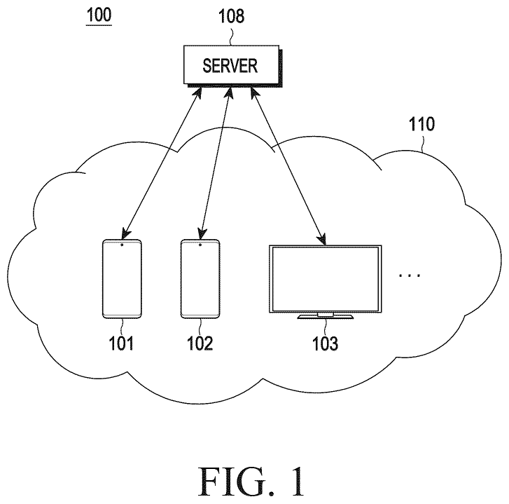

FIG. 1 schematically illustrates a network environment according to an embodiment of the disclosure.

Referring to FIG. 1, the network environment 100 may include multiple electronic devices 101, 102, and 103 and a server 108.

According to an embodiment, the multiple electronic devices 101, 102, and 103 may be included in an intranet 110 (for example, a network inside an organization). For example, the multiple electronic devices 101, 102, and 103 may include various types of electronic devices. Although the multiple electronic devices 101, 102, and 103 are illustrated in FIG. 1 as two smartphones and one PC, the number or type of the electronic devices may not be limited thereto.

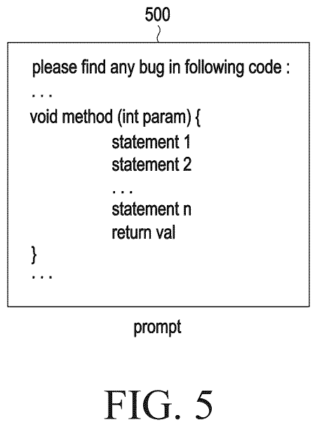

According to an embodiment, the server 108 may provide a generative AI service. For example, the user may access the server 108 that provides a generative AI service through the electronic devices 101, 102, and 103, and may input data (for example, program codes) in the prompt to make a query, thereby acquiring a desired result from the server 108 by means of a large language model (LLM). As an example, the user may access the server 108 that provides a generative AI service through the electronic devices 101, 102, and 103, and may enter input data including a program code in the prompt as illustrated in FIG. 5, thereby requesting the server 108 to find bugs. In case that the program code includes secure data (for example, confidential codes), the secure data may be leaked to the outside of the intranet 110.

In various embodiments described below, various embodiments for identifying whether the program code that has been input in the prompt includes secure data or not, will be described. Components and operations of the network environment 100 described with reference to FIG. 1 will be described hereinafter in more detail with reference to the drawings.

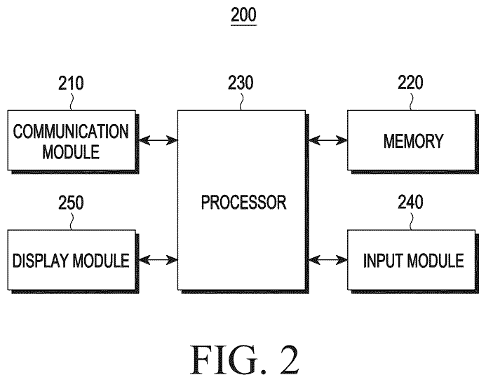

FIG. 2 is a block diagram of an electronic device according to an embodiment of the disclosure.

Referring to FIG. 2, in an embodiment, the electronic device 200 (for example, the electronic device 101, 102, or 103 in FIG. 1) may include a communication module 210, memory 220, a processor 230, an input module 240, and/or a display module 250.

In an embodiment, the communication module 210 may communicate with an external device (for example, the electronic device 102, the electronic device 103, or the server 108 in FIG. 1). In an embodiment, the electronic device 200 may be implemented as a user terminal or a server, but is not limited thereto.

In an embodiment, the communication module 210 may acquire input data from the external device. In another embodiment, the input module 240 may acquire input data that has been input from the user. In an embodiment, the input data may include data for an encoder's training (for example, a program code including multiple code lines). In an embodiment, the input data may be a prompt or information regarding a code which the user has input or is supposed to input to a designated application (for example, an application for using generative artificial intelligence (AI)). In an embodiment, the input data may include a program code including multiple code lines.

In an embodiment, the communication module 210 may acquire secure data from the external device. In an embodiment, the secure data may include data (for example, a program code including secure data) for constructing a database of the secure data through an encoder trained by the input data.

In an embodiment, in case that the electronic device 200 is implemented as a server, the electronic device 200 may acquire the above-described input data or secure data from an external device through the communication module 210. Alternatively, in an embodiment, in case that the electronic device 200 is implemented as an electronic device (for example, a user terminal) other than a server, the electronic device 200 may acquire input data or secure data through the communication module 210, or may acquire input data or secure data, based on data that has been input in the prompt through the input module 240.

In an embodiment, the memory 220 may store various pieces of data used by at least one component of the electronic device 200. The data may include, for example, software and input data or output data regarding commands related thereto. The memory 220 may include volatile memory or nonvolatile memory. Programs may be stored in the memory 220 as software, and may include, for example, operating systems, middleware, or applications. In an embodiment, the memory 220 may store configuration values for locality-sensitive-hashing (LSH) a feature vector in embodiments described later.

In an embodiment, the processor 230 may include one or more processors. In an embodiment, the processor 230 may execute instructions stored in the memory 220, thereby performing various operations.

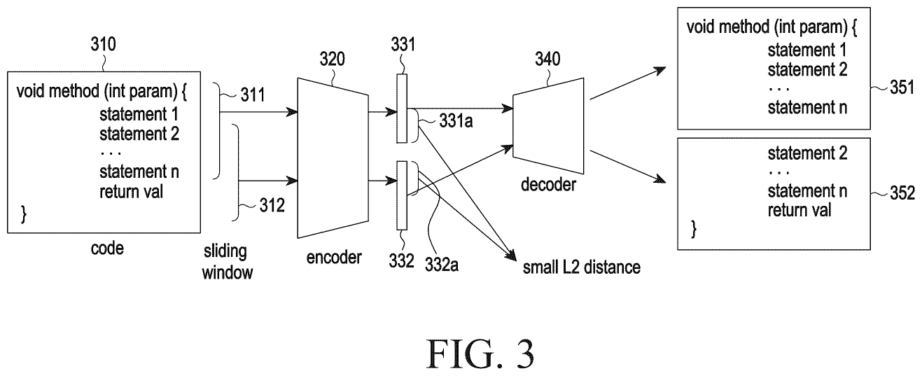

In an embodiment, the processor 230 may train the encoder, based on input data which is input through the input module 240 or is stored in the memory 220, or based on input data received through the communication module 210. Detailed descriptions thereof will be made later with reference to FIG. 3.

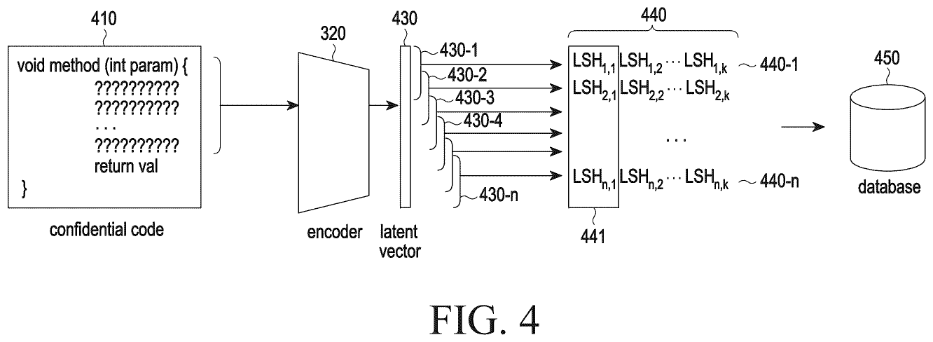

In an embodiment, the processor 230 may encode secure data stored in the memory 220 or secure data received through the communication module 210 through the trained encoder, thereby generating or constructing a database regarding the secure data. Detailed descriptions thereof will be made later with reference to FIG. 4.

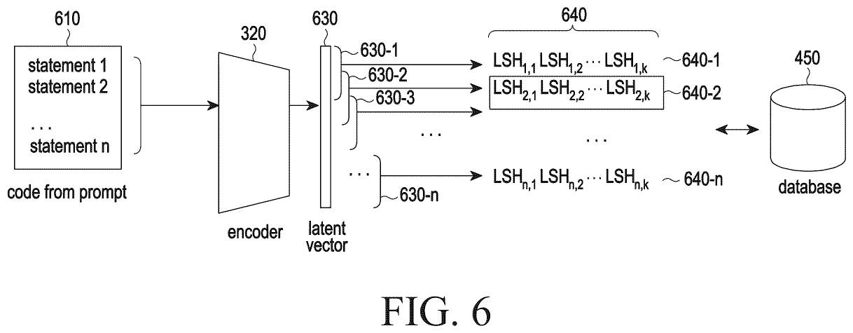

In an embodiment, the processor 230 may encode input data which is input through the input module 240 or is stored in the memory 220, or based on input data received through the communication module 210, through the trained encoder, and may compare the same with secure data stored in the database, thereby identifying whether the input data includes secure data or not. For example, the user may input a code for finding program bugs as the input data through a prompt input screen displayed through the display module 250 as illustrated in FIG. 5. The processor 230 may be configured to display input data that is input through the input module 240 on the prompt input screen. Detailed descriptions thereof will be made later with reference to FIG. 6.

FIG. 3 is a block diagram illustrating an AI model structure for encoder training according to an embodiment of the disclosure.

Referring to FIG. 3, according to an embodiment, the AI model for encoder training may include an encoder 320 and a decoder 340. At least a part of the encoder 320 and the decoder 340 may be implemented by the processor 230 in FIG. 2. According to an embodiment, the encoder 320 may include an auto encoder in which a decoder 340 exists, and is not limited thereto. For example, the encoder 320 and the decoder 340 may be together trained and configured, and the encoder 320 may be trained such that data input to the encoder 320 is identical or similar to data output from the decoder 340. For example, the auto encoder may use an unsupervised learning method which requires no label such that rad data that has been input can be used as a label. For example, the auto encoder may be trained such that data input to the encoder 320 and data output from the decoder 340 have the same value to the maximum extent. The encoder 320 may encode input data so as to generate a low-dimensional representation, thereby self-learning networks.

According to an embodiment, input data 310 that is input to the encoder 320 may include any type of data that can be arranged in multiple lines. For example, the input data 310 may include text data such as a program code. In addition, the input data may include image data that can be configured in a specific format of bitstrings. It will be assumed in embodiments described below, for convenience of description, that text data is an example of the input data.

According to an embodiment, the encoder 320 may split the entire input data 310 into multiple pieces of partial data (e.g., first part data 311 and second part data 312) and then encode the same. For example, the encoder 320 may encode first part data 311 corresponding to a first number of first lines among the entire input data 310, thereby generating a first feature vector (e.g., first part data 311). The feature vector may be referred to as a feature or a latent vector, and is not limited to the terms. For example, the encoder 320 may encode second part data 312 corresponding to a first number of second lines among the entire input data 310, thereby generating a second feature vector 332. According to an embodiment, the first part data 311 and the second part data 312 may have at least some lines overlapping each other. For example, the second part data 312 may have at least some lines configured to overlap at least some lines of the first part data 311 such that the same are encoded in a sliding window type. Although two pieces of first part data 311 and second part data 312 are illustrated in FIG. 3 for convenience of description, the entire input data 310 may be split into three or more pieces of part data, and the three or more pieces of part data may be configured to overlap at least partially and then encoded. Although the first part data 311 and the second part data 312 are configured in FIG. 3 to have the same number (for example, first number), they may be configured to have different numbers.

In an embodiment, the AI model for training the encoder 320 may refer to a model for generating new data that follows the distribution of corresponding data. The AI model may include a generative AI model, but the AI model described below is not limited to a generative AI model. The AI model may learn data's distribution, and the data may have a latent space. The AI model's learning may correspond to learning the latent space, and a latent vector output form the encoder 320 may include a latent variable that the data has. For example, the latent vector may be a latent vector-type variable that the entire data has, and a group of latent vectors may constitute a latent space. In the latent space, pieces of input data to be learned exist in a latent vector distribution type, and the latent distribution that the data has may be learned through the AI model.

According to an embodiment, referring to FIG. 3, first restored data 351 may be generated by decoding the first feature vector 331 obtained by encoding the first part data 311. In addition, second restored data 352 may be generated by decoding the second feature vector 332 obtained by encoding the second part data 312. According to an embodiment, the encoder may be trained such that the first part data 311 and the first restored data 351 becomes identical or similar, and the second part data 312 and the second restored data 352 becomes identical or similar, as described above.

According to an embodiment, the encoder 320 may be configured such that, according to the position of specific data (for example, a specific code) in the input data 310, the same is encoded in the identical or similar position in the feature vectors 331 and 332 as well. For example, an objective function may be added to the encoder 320 to reduce the L2 distance such that values corresponding to positions in which corresponding pieces of first part data 311 and second part 312 overlap each other in the first feature vector 331 and the second feature vector 332 are identical or similar to each other. For example, overlapping parts of the first part data 311 and the second part data 312 may be disposed in different positions on the first feature vector 331 and the second feature vector 332. For example, a part of the first part data 311, which overlaps the second part data 312, may be disposed on the lower portion 331a of the first feature vector 331, and a part of the second part data 312, which overlaps the first part data 311, may be disposed on the upper portion 332a of the second feature vector 332. For example, in case that the encoder 320 is trained such that the lower portion 331a of the first feature vector 331 and the upper portion 332a of the second feature vector 332 have identical or similar values, a code snippet including a specific code among the entire input data 310 may be disposed in a position corresponding to the specific code on a feature vector. For example, in case that an objective function is added and trained to train the encoder 320 such that the lower portion 331a of the first feature vector 331 and the upper portion 332a of the second feature vector 332 have identical or similar values, the encoder 320 may be trained such that the same has a meaning even with a part of a feature vector.

According to various embodiments, when the encoder 320 is trained as described above, an objective function for reducing the L2 distance and a function for encoding of an auto encoder may be trained simultaneously and, by adjusting the weight between the two, adjustment may be possible regarding whether to focus on the entire code that has been input or to focus on a code corresponding to the position of a feature vector. According to various embodiments, encoding with an objective function added to train the encoder 320 as described above may be referred to as spatial locality preserving encoding, but is not limited to the term.

FIG. 4 is a block diagram illustrating a procedure of encoding secure data by an AI model according to an embodiment of the disclosure.

Referring to FIG. 4, according to an embodiment, the processor 230 may encode secure data by using the encoder trained in FIG. 3, thereby generating or constructing a database of secure data (for example, confidential codes).

According to an embodiment, secure data 410 may be encoded by the encoder 320 trained in FIG. 3. According to an embodiment, secure data 410 that is input to the encoder 320 may include any type of data that can be arranged in multiple lines. For example, the secure data 410 may include text data such as a program code. In addition, the secure data may include image data that can be configured in a specific format of bitstrings. The secure data may at least partially include a confidential code.

According to an embodiment, the encoder 320 may generate a feature vector 430 by encoding secure data 410 that is input thereto. The feature vector may be referred to as a feature or a latent vector, and is not limited to the terms.

According to an embodiment, the processor 230 may generate a hash value 440 by locality-sensitive-hashing (LSH) the feature vector 430. For convenience of description, the hash value obtained through locality-sensitive-hashing will be referred to as an “LSH.” According to an embodiment, the feature vector 430 may be divided into multiple parts and then locality-sensitive-hashed. For example, the feature vector 430 may be divided into a first feature vector 430-1 corresponding to a first part, a second feature vector 430-2 corresponding to a second part, a third feature vector 430-3 corresponding to a third part, a fourth feature vector 430-4 corresponding to a fourth part, . . . , an n^{th} feature vector 430-n corresponding to an n^{th} part. Each part may at least partially overlap an adjacent part.

According to an embodiment, the locality-sensitive-hashing may be configured as in Equation 1 below, but is not limited thereto.

$$LSH ( q ) = floor ( \frac{q \cdot x + b}{w} ) \qquad Equation 1$$

In Equation 1, q may refer to a feature vector, and x, b, and w may correspond to configuration values of the locality-sensitive-hashing. x may indicate in which direction the feature vector is projected, and b and w may be values for configuring the locality-related sensitivity.

According to an embodiment, the LSH is not limited to a specific hash function, and may be defined as a function encompassing a wide range of concept which may be defined by the following parameters:
Distance metric: d
Approximation factor: c>1
Threshold r>0
Probability p₁>p₂

The hash function h may be referred to as a locality-sensitive hash in case that with regard to all element pairs, by using the parameters, the probability that two elements will have the same hash value when the distance between the two elements is smaller than or equal to r is larger than the minimum of p₁, and the probability that two elements will have the same hash value when the distance between the two elements is larger than or equal to c*r is smaller than the maximum of p₂. In addition, such a hash function may be defined to be (r, cr, p₁, p₂) sensitive. For example, a function may be defined as the LSH function according to the disclosure if the probability that two elements will have the same hash value when the two elements are close to each other is larger than the probability that two elements will have the same hash value when the two elements are far from each other.

According to an embodiment, the processor 230 may generate multiple hash values by performing locality-sensitive-hashing multiple times with different configuration values with regard to respective multiple (for example, n) feature vectors 430-1, 430-2, 430-3, 430-4, . . . , 430-n corresponding to respective parts. According to an embodiment, the processor 230 may generate as many LSHs 440-1 as k by locality-sensitive-hashing the first feature vector 430-1 by means of k configuration values. For example, the processor 230 may generate LSH_{1,1} by locality-sensitive-hashing the first feature vector 430-1 by means first configuration values (for example, x₁, b₁, w₁), may generate LSH_{1,2} by locality-sensitive-hashing the same by means of second configuration values (for example, x₂, b₂, w₂), and may generate LSH_{1,k} by locality-sensitive-hashing the same by means of k^{th} configuration values (for example, xₖ, bₖ, wₖ).

According to an embodiment, the processor 230 may generate as many LSHs 440-2 as k by locality-sensitive-hashing the second feature vector 430-2 by means of k configuration values. For example, the processor 230 may generate LSH_{2,1} by locality-sensitive-hashing the second feature vector 430-2 by means first configuration values (for example, x₁, b₁, w₁), may generate LSH_{2,2} by locality-sensitive-hashing the same by means of second configuration values (for example, x₂, b₂, w₂), and may generate LSH_{2,k} by locality-sensitive-hashing the same by means of k^{th} configuration values (for example, xₖ, bₖ, wₖ).

According to an embodiment, the processor 230 may generate as many LSHs 440-n as k by locality-sensitive-hashing the n^{th} feature vector 430-n by means of k configuration values. For example, the processor 230 may generate LSH_{n,1} by locality-sensitive-hashing the n^{th} feature vector 430-n by means of first configuration values (for example, x₁, b₁, w₁), may generate LSH_{n,2} by locality-sensitive-hashing the same by means of second configuration values (for example, x₂, b₂, w₂), and may generate LSH_{n,k} by locality-sensitive-hashing the same by means of k^{th} configuration values (for example, xₓ, bₖ, wₖ).

According to an embodiment, the processor 230 may conduct locality-sensitive-hashing multiple times with regard to respective multiple (for example, n) feature vectors 430-1, 430-2, 430-3, 430-4, . . . , 430-n corresponding to respective parts of the feature vector 430 by using different configuration values, and may store multiple hash values 440 generated accordingly in the database 450 as hash values regarding the confidential code.

According to an embodiment, configuration values regarding feature vectors corresponding to respective parts may be configured identically or differently. For example, as illustrated in FIG. 4, configuration values of first LSHs 441 (LSH_{1,1}, LSH_{2,1}, . . . , LSH_{n,1}) to which first configuration values (for example, x₁, b₁, w₁) of respective feature vectors 430-1, 430-2, 430-3, 430-4, . . . , 430-n are applied may all be configured identically, and at least some configuration values may be configured differently.

FIG. 5 is a block diagram illustrating a prompt input example according to an embodiment of the disclosure.

Referring to FIG. 5, as described above, the user may access the server 108 that provides a generative AI service through the electronic device 200 (for example, the electronic device 101, 102, or 103 in FIG. 1), and may input data (for example, a program code) in the prompt 500 to make a query, thereby acquiring a desired result from the server 108 by means of a large language model (LLM). As an example, the user may access the server 108 that provides a generative AI service through the electronic device 101, 102, or 103, and may enter input data including a program code in the prompt as illustrated in FIG. 5, thereby requesting the server 108 to find bugs (for example, may enter “please find any bug in following code”: to make a request). According to an embodiment, as will be described later with reference to FIG. 6, the input data may be encoded by the trained encoder 320 and then locality-sensitive-hashed, and may be compared with a hash value corresponding to secure data (for example, a confidential code) stored in the database, thereby identifying whether the input data includes secure data or not.

FIG. 6 is a block diagram illustrating a procedure of detecting secure data with regard to input data according to an embodiment of the disclosure.

Referring to FIG. 6, according to an embodiment, the processor 230 may encode input data 610 corresponding to input data input in the prompt, as illustrated in FIG. 5, or at least a part of the input data (hereinafter, referred to as input data for convenience of description) by means of the encoder 320 trained in FIG. 3.

According to an embodiment, the encoder 320 may encode the input data 610, thereby generating a feature vector 630. The feature vector may be referred to as a feature or a latent vector, and is not limited to the terms.

According to an embodiment, the processor 230 may locality-sensitive-hash the feature vector 630, thereby generating a hash value 640. For convenience of description, the hash value obtained through locality-sensitive-hashing will be referred to as an “LSH.” According to an embodiment, the feature vector 630 may be divided into multiple parts and then locality-sensitive-hashed. For example, the feature vector 630 may be divided into a first feature vector 630-1 corresponding to a first part, a second feature vector 630-2 corresponding to a second part, a third feature vector 630-3 corresponding to a third part, a fourth feature vector 630-4 corresponding to a fourth part, . . . , an n^{th} feature vector 630-n corresponding to an n^{th} part. Each part may at least partially overlap an adjacent part.

According to an embodiment, the processor 230 may generate multiple hash values by performing locality-sensitive-hashing multiple times with different configuration values with regard to respective multiple (for example, n) feature vectors 630-1, 630-2, 630-3, 630-4, . . . , 630-n corresponding to respective parts. According to an embodiment, the processor 230 may generate as many LSHs 640-1 as k by locality-sensitive-hashing the first feature vector 630-1 by means of k configuration values. For example, the processor 230 may generate LSH_{1,1} by locality-sensitive-hashing the first feature vector 630-1 by means first configuration values (for example, x₁, b₁, w₁), may generate LSH_{1,2} by locality-sensitive-hashing the same by means of second configuration values (for example, x₂, b₂, w₂), and may generate LSH_{1,k} by locality-sensitive-hashing the same by means of k^{th} configuration values (for example, xₖ, bₖ, wₖ).

According to an embodiment, the processor 230 may generate as many LSHs 640-2 as k by locality-sensitive-hashing the second feature vector 630-2 by means of k configuration values. For example, the processor 230 may generate LSH_{2,1} by locality-sensitive-hashing the second feature vector 630-2 by means first configuration values (for example, x₁, b₁, w₁), may generate LSH_{2,2} by locality-sensitive-hashing the same by means of second configuration values (for example, x₂, b₂, w₂), and may generate LSH_{2,k} by locality-sensitive-hashing the same by means of k^{th} configuration values (for example, xₖ, bₖ, wₖ).

According to an embodiment, the processor 230 may generate as many LSHs 640-n as k by locality-sensitive-hashing the n^{th} feature vector 630-n by means of k configuration values. For example, the processor 230 may generate LSH_{n,1} by locality-sensitive-hashing the n^{th} feature vector 630-n by means first configuration values (for example, x₁, b₁, w₁), may generate LSH_{n,2} by locality-sensitive-hashing the same by means of second configuration values (for example, x₂, b₂, w₂), and may generate LSH_{n,k} by locality-sensitive-hashing the same by means of k^{th} configuration values (for example, xₖ, bₖ, wₖ).

According to an embodiment, the processor 230 may conduct locality-sensitive-hashing multiple times with regard to respective multiple (for example, n) feature vectors 630-1, 630-2, 630-3, . . . , 630-n corresponding to respective parts of the feature vector 630, and may compare multiple hash values 640 generated accordingly with hash values stored in the database 450. According to an embodiment, the processor 230 may conduct locality-sensitive-hashing multiple times with regard to respective multiple (for example, n) feature vectors 630-1, 630-2, 630-3, . . . , 630-n corresponding to respective parts of the feature vector 630, by using identical or different configuration values, thereby generating multiple hash values 640.

According to an embodiment, the processor 230 may determine or identify whether the input data 610 includes secure data or not, based on the result of comparison. For example, in case that a comparison between k LSHs 640-1 generated by locality-sensitive-hashing the first feature vector 630-1 by means of k configuration values and k LSHs stored in the database 450 confirms that k LSHs are all identical, or the number of identical LSHs corresponds to a configured ratio or larger, the processor 230 may determine or identify that the input data 610 includes secure data. In addition, in case that a comparison between k LSHs 640-2 generated by locality-sensitive-hashing the second feature vector 630-2 by means of k configuration values and k LSHs stored in the database 450 confirms that k LSHs are all identical, or the number of identical LSHs corresponds to a configured ratio or larger, the processor 230 may determine or identify that the input data 610 includes secure data. For example, in case that a comparison between k LSHs 640-n generated by locality-sensitive-hashing the n^{th} feature vector 630-n by means of k configuration values and k LSHs stored in the database 450 confirms that k LSHs are all identical, or the number of identical LSHs corresponds to a configured ratio or larger, the processor 230 may determine or identify that the input data 610 includes secure data.

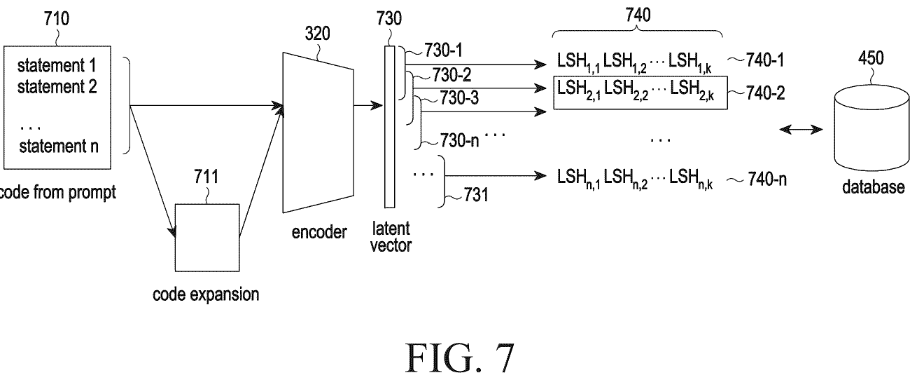

FIG. 7 is a block diagram illustrating a procedure of detecting secure data with regard to input data according to an embodiment of the disclosure.

Referring to FIG. 7, according to an embodiment, the processor 230 may encode input data 710 corresponding to input data input in the prompt, as illustrated in FIG. 5, or at least a part of the input data (hereinafter, referred to as input data for convenience of description) by means of the encoder 320 trained in FIG. 3.

According to an embodiment, the processor 230 may compare the size of input data 710 corresponding to input data input in the prompt or at least a part of the input data with the input size configured for the encoder 320. In case that the size of the input data 710 is smaller than the input size configured for the encoder 320 as a result of the comparison, the size of the input data 710 may be expanded or increased by the input size configured for the encoder 320 through a code expansion unit 711. According to an embodiment, the code expansion unit 711 may increase the size of input data 710 that has been input through zero padding or expansion using generative model-based learning.

According to an embodiment, the encoder 320 may encode the input data 710, thereby generating a feature vector 730. The feature vector may be referred to as a feature or a latent vector, and is not limited to the terms.

According to an embodiment, the processor 230 may locality-sensitive-hash the feature vector 730, thereby generating a hash value 740. For convenience of description, the hash value obtained through locality-sensitive-hashing will be referred to as an “LSH.” According to an embodiment, Euclidean LSHs may be used as the LSHs, but are not limitative. According to an embodiment, the feature vector 730 may be divided into multiple parts and then locality-sensitive-hashed. For example, the feature vector 730 may be divided into a first feature vector 730-1 corresponding to a first part, a second feature vector 730-2 corresponding to a second part, a third feature vector 730-3 corresponding to a third part, . . . , an n^{th} feature vector 730-n corresponding to an n^{th} part. Each part may at least partially overlap an adjacent part. According to an embodiment, the processor 230 may locality-sensitive-hash values of the feature vector 731 corresponding to parts increased through the code expansion unit 711 without including the same in a sliding window. False positives may be reduced by not including the values of the feature vector 731 corresponding to parts increased through the code expansion unit 711 in the sliding window.

According to an embodiment, the processor 230 may generate multiple hash values by performing locality-sensitive-hashing multiple times with different configuration values with regard to respective multiple (for example, n) feature vectors 730-1, 730-2, 730-3, . . . , 730-n corresponding to respective parts. According to an embodiment, the processor 230 may generate as many LSHs 740-1 as k by locality-sensitive-hashing the first feature vector 730-1 by means of k configuration values. For example, the processor 230 may generate LSH_{1,1} by locality-sensitive-hashing the first feature vector 730-1 by means first configuration values (for example, x₁, b₁, w₁), may generate LSH_{1,2} by locality-sensitive-hashing the same by means of second configuration values (for example, x₂, b₂, w₂), and may generate LSH_{1,k} by locality-sensitive-hashing the same by means of k^{th} configuration values (for example, xₖ, bₖ, wₖ).

According to an embodiment, the processor 230 may generate as many LSHs 740-2 as k by locality-sensitive-hashing the second feature vector 730-2 by means of k configuration values. For example, the processor 230 may generate LSH_{2,1} by locality-sensitive-hashing the second feature vector 730-2 by means first configuration values (for example, x₁, b₁, w₁), may generate LSH_{2,2} by locality-sensitive-hashing the same by means of second configuration values (for example, x₂, b₂, w₂), and may generate LSH_{2,k} by locality-sensitive-hashing the same by means of k^{th} configuration values (for example, xₖ, bₖ, wₖ).

According to an embodiment, the processor 230 may conduct locality-sensitive-hashing multiple times with different configuration values with regard to respective multiple (for example, n) feature vectors 730-1, 730-2, 730-3, . . . , 730-n corresponding to respective parts of the feature vector 730, and may compare multiple hash values 740 generated accordingly with hash values stored in the database 450.

According to an embodiment, the processor 230 may determine or identify whether the input data 710 includes secure data or not, based on the result of comparison. For example, in case that a comparison between k LSHs 740-1 generated by locality-sensitive-hashing the first feature vector 730-1 by means of k configuration values and k LSHs stored in the database 450 confirms that k LSHs are all identical, or the number of identical LSHs corresponds to a configured ratio or larger, the processor 230 may determine or identify that the input data 710 includes secure data. In addition, in case that a comparison between k LSHs 740-2 generated by locality-sensitive-hashing the second feature vector 730-2 by means of k configuration values and k LSHs stored in the database 450 confirms that k LSHs are all identical, or the number of identical LSHs corresponds to a configured ratio or larger, the processor 230 may determine or identify that the input data 710 includes secure data. For example, in case that a comparison between k LSHs 740-n generated by locality-sensitive-hashing the n^{th} feature vector 730-n by means of k configuration values and k LSHs stored in the database 450 confirms that k LSHs are all identical, or the number of identical LSHs corresponds to a configured ratio or larger, the processor 230 may determine or identify that the input data 710 includes secure data.

According to an embodiment, various methods may be applied to identify whether all of the k hash values included in respective LSHs 740-1, 740-2, . . . 740-n corresponding to respective feature vectors exist in the database 450 or not, and the same is not limited to a specific method. For example, the processor 230 may concatenate the k hash values included in respective LSHs 740-1, 740-2, . . . 740-n corresponding to respective feature vectors, and may then hash the same by means of a secure hash algorithm (SHA). According to another embodiment, the processor 230 may use a bloom filter to identify whether all of the k hash values included in respective LSHs 740-1, 740-2, . . . 740-n corresponding to respective feature vectors exist in the database 450 or not. Hereinafter, an example in which the SHA is used to identify whether input data 710 includes secure data or not will be described, and the method described below is not limitative.

According to an embodiment, a feature vector qᵢ to be inspected currently may correspond to a part of a feature vector (for example, latent vector) obtained through a sliding window. The feature vector qᵢ may be expressed as in Equation 2 below:

$${q}_{i} = v [ i \times s : i \times s + {I}_{2} ] \qquad Equation 2$$

In Equation 2, i may correspond to the i^{th} feature vector. Assuming that I₂ is the sliding window size, and I₁ is the feature vector size, 1≤I₂≤I₁ may hold. s is a unit value of movement of the sliding window, and may be 1 or larger.

According to an embodiment, the processor 230 may obtain values LSH_{i,1}(q), LSH_{i,2}(q), . . . , LSH_{i,k}(q) by calculating k LSHs with regard to each qᵢ. The acquired values may be input to a hash function such as SHA1, SHA2, or SHA256, thereby obtaining a hash value (or hash key value) as in Equation 3 below:

$$key = SHA 1 ( {LSH}_{i , 1} ( q ) + {LSH}_{i , 2} ( q ) + … + {LSH}_{i , k} ( q ) ) \qquad Equation 3$$

According to an embodiment, the additive operation (+) in Equation 3 above may be replaced with a concatenation operation. For example, the processor 230 may inspect whether the hash value (or hash key value) exists in a hash table T corresponding to secure data stored in the database 450, thereby identifying whether qᵢ is a code that exists in the database 450. According to an embodiment, the hash table T may have on/off-type indications indicating whether corresponding key values exist in the database 450 or not, but this is not limitative. According to an embodiment, the database 450 may store snippets of feature vectors (for example, latent vectors) used during generation. In case that snippets of the feature vectors are stored in the database 450, false positives resulting from hash collision may be reduced. According to an embodiment, the hash table T may be generated with regard to each file or project, and multiple projects may be managed with one hash table for space utilization.

According to an embodiment, as described above, the feature vector 730 may be split into n parts and then calculated by k LSHs, respectively. The processor 230 may identify or determines that a confidential code exists if there is just one case in which the k LSH values are all identical among n cases in the database 450. According to an embodiment, a sliding window may be used, as described above, to split the feature vector 730 into n parts. Multiple windows having different window sizes may be used, and the overall throughput may be improved by identifying whether secure data exists or not, starting from the window having a relatively large size, such use of a sliding window, as described above, to split the feature vector 730 into n parts may guarantee that, even if only a part of the code of input data 710 that has been input in the prompt includes secure data (for example, a confidential code), the same can be detected.

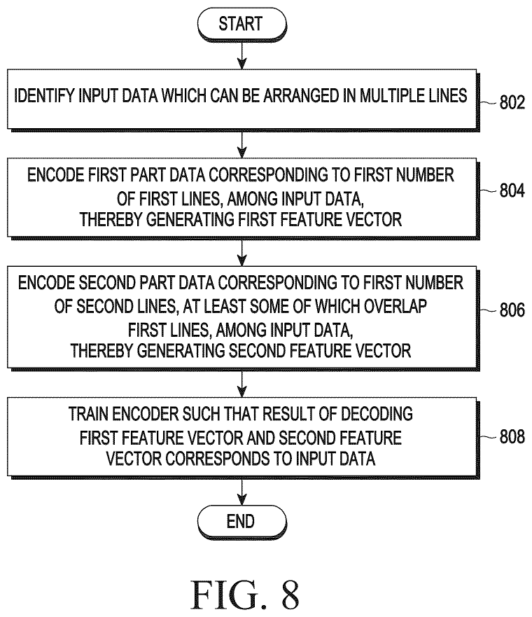

FIG. 8 is a flowchart illustrating a method for training an encoder according to an embodiment of the disclosure.

Referring to FIG. 8, an electronic device 200 may include memory 220 and a processor 230. According to an embodiment, the processor 230 may identify input data which can be arranged in multiple lines stored in the memory 220, in operation 802.

According to an embodiment, the processor 230 may encode first part data corresponding to a first number of first lines among the input data by an encoder 320, thereby generating a first feature vector, in operation 804.

According to an embodiment, the processor 230 may encode second part data corresponding to the first number of second lines, at least some of which overlap the first lines, among the input data by the encoder 320, thereby generating a second feature vector, in operation 806.

According to an embodiment, the processor 230 may be configured to train the encoder 320 such that the result of decoding the first feature vector and the second feature vector by a decoder 340 corresponding to the encoder 320 corresponds to the input data, in operation 808.

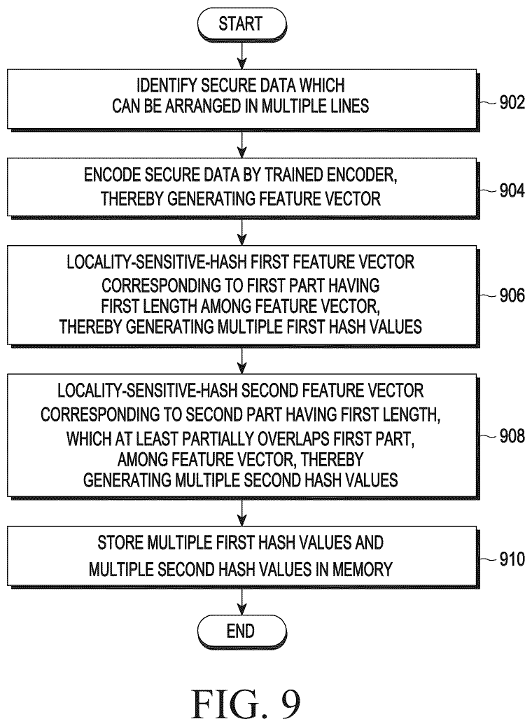

FIG. 9 is a flowchart illustrating a method for generating a database of secure data according to an embodiment of the disclosure.

Referring to FIG. 9, an electronic device 200 may include memory 220 and a processor 230. According to an embodiment, the processor 230 may identify secure data which can be arranged in multiple lines, in operation 902.

According to an embodiment, the processor 230 may encode the secure data by a trained encoder, thereby generating feature vectors, in operation 904.

According to an embodiment, the processor 230 may locality-sensitive-hash a first feature vector corresponding to a first part having a first length among the feature vectors, based on multiple first configuration values, thereby generating multiple first hash values, in operation 906.

According to an embodiment, the processor 230 may locality-sensitive-hash a second feature vector corresponding to a second part having the first length, which at least partially overlaps the first part, among the feature vectors, based on multiple second configuration values, thereby generating multiple second hash values, in operation 908.

According to an embodiment, the processor 230 may be configured to store the multiple first hash values and the multiple second hash values in the memory 220, in operation 910.

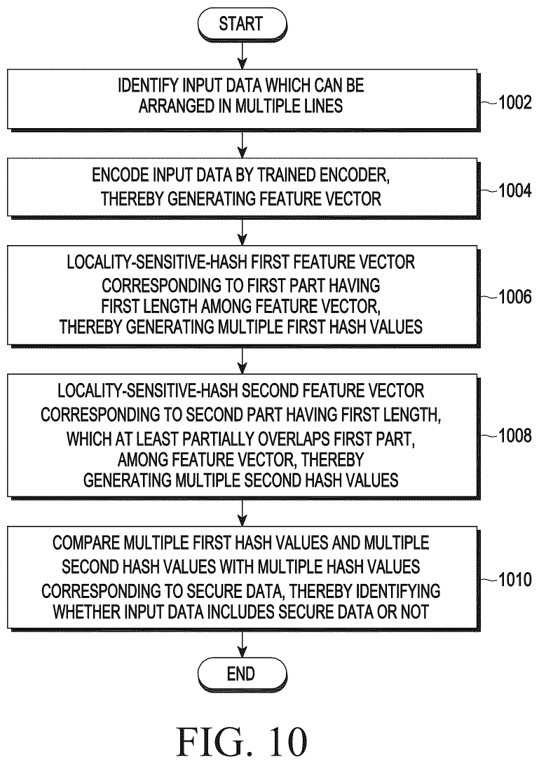

FIG. 10 is a flowchart illustrating a method for detecting secure data with regard to input data according to an embodiment of the disclosure.

Referring to FIG. 10, an electronic device 200 may include memory 220 and a processor 230. According to an embodiment, the processor 230 may identify input data which can be arranged in multiple lines, in operation 1002.

According to an embodiment, the processor 230 may encode the secure data by a trained encoder, thereby generating feature vector, in operation 1004.

According to an embodiment, the processor 230 may locality-sensitive-hash a first feature vector corresponding to a first part having a first length among the feature vectors, based on multiple first configuration values, thereby generating multiple first hash values, in operation 1006.

According to an embodiment, the processor 230 may locality-sensitive-hash a second feature vector corresponding to a second part having the first length, which at least partially overlaps the first part, among the feature vectors, based on multiple second configuration values, thereby generating multiple second hash values, in operation 1008.

According to an embodiment, the processor 230 may be configured to compare the multiple first hash values and the multiple second hash values with multiple hash values corresponding to secure data stored in the memory, thereby identifying whether the input data includes secure data or not, in operation 1010.

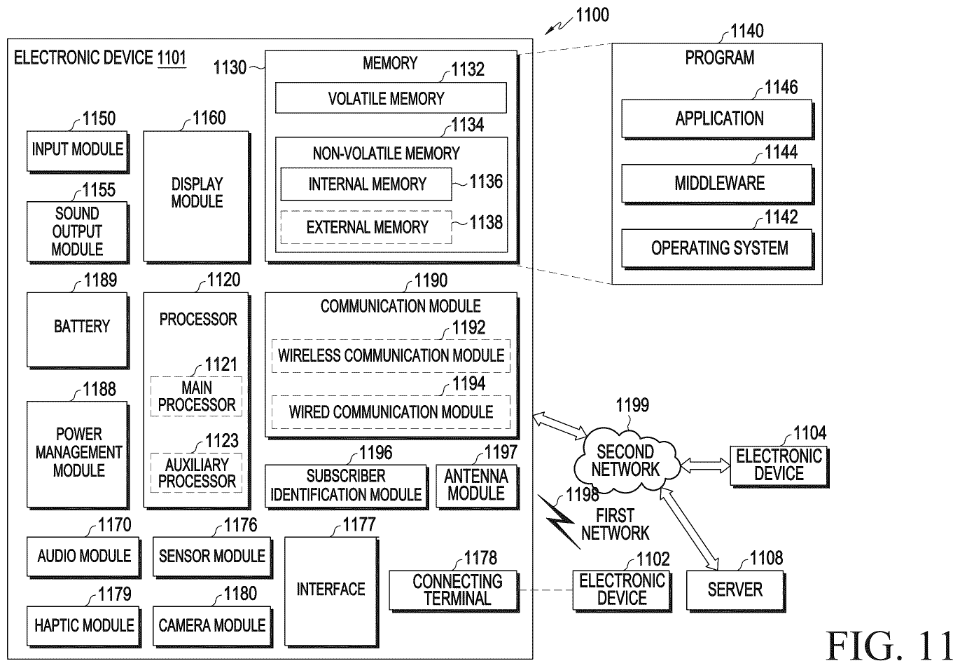

FIG. 11 is a block diagram illustrating an electronic device 1101 in a network environment 1100 according to an embodiment of the disclosure.

Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to one embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, a HDMI connector, a USB connector, a SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to one embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the millimeter wave (mmWave) band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or server 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

According to an embodiment, an electronic device may include memory and a processor. The processor may be configured to: identify input data which can be arranged in multiple lines stored in the memory; generate a first feature vector by encoding first part data corresponding to a first number of first lines among the input data by an encoder; generate a second feature vector by encoding second part data corresponding to the first number of second lines, the second lines at least partially overlapping the first lines, among the input data by the encoder; and train the encoder such that a result of decoding the first feature vector and the second feature vector by a decoder corresponding to the encoder corresponds to the input data.

According to an embodiment, the input data may include text data corresponding to a program code.

According to an embodiment, the encoder may include an auto encoder.

According to an embodiment, the processor may be configured to train the encoder by adding an objective function so as to train the encoder such that a first part of the first feature vector and a second part of the second feature vector have identical or similar values.

According to an embodiment, the processor may be configured to simultaneously train a function for encoding and the objective function while adjusting weights of the function for encoding and weights of the objective function.

According to an embodiment, an electronic device may include memory and a processor. The processor may be configured to: identify secure data which can be arranged in multiple lines; generate feature vectors by encoding the secure data by a trained encoder; generate multiple first hash values by performing a locality-sensitive-hashing (LSH) operation on a first feature vector corresponding to a first part having a first length among the feature vectors, based on multiple first configuration values; generate multiple second hash values by performing the LSH operation on a second feature vector corresponding to a second part having the first length, the second part at least partially overlapping the first part, among the feature vectors, based on multiple second configuration values; and store the multiple first hash values and the multiple second hash values in the memory.

According to an embodiment, the secure data may include text data corresponding to a program code.

According to an embodiment, the LSH operation may be configured by the following Equation:

$$LSH ( q ) floor ( \frac{q \cdot x + b}{w} )$$

in the Equation, q may refer to a feature vector, x may indicate in which direction the feature vector is projected, and b and w may refer to values which configure locality-related sensitivity.

According to an embodiment, the multiple first configuration values may be configured as a first set including multiple different configuration values, and the multiple second configuration values may be configured as a second set including multiple different configuration values.

According to an embodiment, multiple configuration values included in the first set may correspond to multiple configuration values included in the second set.

According to an embodiment, an electronic device may include memory and a processor. The processor may be configured to: identify input data which can be arranged in multiple lines; generate feature vectors by encoding the input data by a trained encoder; generate multiple first hash values by performing a locality-sensitive-hashing (LSH) operation on a first feature vector corresponding to a first part having a first length among the feature vectors, based on multiple first configuration values; generate multiple second hash values by performing the LSH operation on a second feature vector corresponding to a second part having the first length, the second part at least partially overlapping the first part, among the feature vectors, based on multiple second configuration values; and identify whether the input data includes secure data or not by comparing the multiple first hash values and the multiple second hash values with multiple hash values corresponding to the secure data stored in the memory.

According to an embodiment, the input data may include text data corresponding to a program code.

According to an embodiment, the LSH operation may be configured by the following Equation:

$$LSH ( q ) floor ( \frac{q \cdot x + b}{w} )$$

in the Equation, q may refer to a feature vector, x may indicate in which direction the feature vector is projected, and b and w may refer to values which configure locality-related sensitivity.

According to an embodiment, the multiple first configuration values may be configured as a first set including multiple different configuration values, and the multiple second configuration values may be configured as a second set including multiple different configuration values.

According to an embodiment, multiple configuration values included in the first set may correspond to multiple configuration values included in the second set.

According to an embodiment, the processor may be configured to: compare the input data's size with an input size configured for the encoder; and expand the input data's size to a size corresponding to the input size in case that the input data's size is smaller than the input size configured for the encoder as a result of the comparison.

According to an embodiment, a method for filtering secure data may include: identifying input data which can be arranged in multiple lines; generating feature vectors by encoding the input data by a trained encoder; generating multiple first hash values by performing a locality-sensitive-hashing (LSH) operation on a first feature vector corresponding to a first part having a first length among the feature vectors, based on multiple first configuration values; generating multiple second hash values by the LSH operation on a second feature vector corresponding to a second part having the first length, the second part at least partially overlapping the first part, among the feature vectors, based on multiple second configuration values; and identifying whether the input data includes secure data or not by comparing the multiple first hash values and the multiple second hash values with multiple hash values corresponding to the secure data.

According to an embodiment, the input data may include text data corresponding to a program code.

According to an embodiment, the LSH operation may be configured by the following Equation:

$$LSH ( q ) floor ( \frac{q \cdot x + b}{w} )$$

in the Equation, q may refer to a feature vector, x may indicate in which direction the feature vector is projected, and b and w may refer to values which configure locality-related sensitivity.

According to an embodiment, the multiple first configuration values may be configured as a first set including multiple different configuration values, and the multiple second configuration values may be configured as a second set including multiple different configuration values.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions; and
one or more processors communicatively coupled to the memory,
wherein the instructions, when executed by the one or more processors individually or collectively, cause the electronic device to:
identify input data, which can be arranged in multiple lines, stored in the memory,
generate a first feature vector by encoding, using an encoder, first part data corresponding to a first number of first lines among the input data,
generate a second feature vector by encoding, using the encoder, second part data corresponding to the first number of second lines, the second lines at least partially overlapping the first lines, among the input data, and
train the encoder such that a result of decoding the first feature vector and the second feature vector by a decoder corresponding to the encoder corresponds to the input data.

2. The electronic device of claim 1, wherein the input data comprises text data corresponding to a program code.

3. The electronic device of claim 1, wherein the encoder comprises an auto encoder.

4. The electronic device of claim 1, wherein the instructions, when executed by the one or more processors individually or collectively, further cause the electronic device to train the encoder by adding an objective function so as to train the encoder such that a first part of the first feature vector and a second part of the second feature vector have identical or similar values.

5. The electronic device of claim 4, wherein the instructions, when executed by the one or more processors individually or collectively, further cause the electronic device to simultaneously train a function for encoding and the objective function while adjusting weights of the function for encoding and weights of the objective function.

6. An electronic device comprising:
memory, comprising one or more storage media, storing instructions; and
one or more processors communicatively coupled to the memory,
wherein the instructions, when executed by the one or more processors individually or collectively, cause the electronic device to:
identify secure data which can be arranged in multiple lines,
generate feature vectors by encoding the secure data by a trained encoder,
generate multiple first hash values by performing a locality-sensitive-hashing (LSH) operation on a first feature vector corresponding to a first part having a first length among the feature vectors, based on multiple first configuration values,
generate multiple second hash values by performing the LSH operation on a second feature vector corresponding to a second part having the first length, the second part at least partially overlapping the first part, among the feature vectors, based on multiple second configuration values, and
store the multiple first hash values and the multiple second hash values in the memory.

7. The electronic device of claim 6, wherein the secure data comprises text data corresponding to a program code.

8. The electronic device of claim 6, wherein the LSH operation is configured by the following Equation:
$$LSH ( q ) floor ( \frac{q \cdot x + b}{w} )$$
in the Equation, q refers to a feature vector, x indicates in which direction the feature vector is projected, and b and w refer to values which configure locality-related sensitivity.

9. The electronic device of claim 6,
wherein the multiple first configuration values are configured as a first set comprising multiple different configuration values, and
wherein the multiple second configuration values are configured as a second set comprising multiple different configuration values.

10. The electronic device of claim 9, wherein the multiple different configuration values included in the first set correspond to the multiple different configuration values included in the second set.

11. An electronic device comprising:
memory, comprising one or more storage media, storing instructions; and
one or more processors communicatively coupled to the memory,
wherein the instructions, when executed by the one or more processors individually or collectively, cause the electronic device to:
identify input data which can be arranged in multiple lines,
generate feature vectors by encoding the input data by a trained encoder,
generate multiple first hash values by performing a locality-sensitive-hashing (LSH) operation on a first feature vector corresponding to a first part having a first length among the feature vectors, based on multiple first configuration values,
generate multiple second hash values by performing the LSH operation on a second feature vector corresponding to a second part having the first length, the second part at least partially overlapping the first part, among the feature vectors, based on multiple second configuration values, and
identify whether the input data comprises secure data or not by comparing the multiple first hash values and the multiple second hash values with multiple hash values corresponding to the secure data stored in the memory.

12. The electronic device of claim 11, wherein the input data comprises text data corresponding to a program code.

13. The electronic device of claim 11, wherein the LSH operation is configured by the following Equation:
$$LSH ( q ) floor ( \frac{q \cdot x + b}{w} )$$
in the Equation, q refers to a feature vector, x indicates in which direction the feature vector is projected, and b and w refer to values which configure locality-related sensitivity.

14. The electronic device of claim 13,
wherein the multiple first configuration values are configured as a first set comprising multiple different configuration values, and
wherein the multiple second configuration values are configured as a second set comprising multiple different configuration values.

15. The electronic device of claim 14, wherein the multiple different configuration values included in the first set correspond to the multiple different configuration values included in the second set.

16. The electronic device of claim 11, wherein the instructions, when executed by the one or more processors individually or collectively, further cause the electronic device to:
compare a size of the input data with an input size configured for the encoder; and
expand the size of the input data to a size corresponding to the input size in case that the size of the input data is smaller than the input size configured for the encoder as a result of the comparison.

17. A method for filtering secure data, the method comprising:
identifying input data which can be arranged in multiple lines;
generating feature vectors by encoding the input data by a trained encoder;
generating multiple first hash values by performing a locality-sensitive-hashing (LSH) operation on a first feature vector corresponding to a first part having a first length among the feature vectors, based on multiple first configuration values;
generating multiple second hash values by performing the LSH operation on a second feature vector corresponding to a second part having the first length, the second part at least partially overlapping the first part, among the feature vectors, based on multiple second configuration values; and
identifying whether the input data comprises secure data or not by comparing the multiple first hash values and the multiple second hash values with multiple hash values corresponding to the secure data.

18. The method of claim 17, wherein the input data comprises text data corresponding to a program code.

19. The method of claim 17, wherein the LSH operation is configured by the following Equation:
$$LSH ( q ) floor ( \frac{q \cdot x + b}{w} )$$
in the Equation, q refers to a feature vector, x indicates in which direction the feature vector is projected, and b and w refer to values which configure locality-related sensitivity.

20. The method of claim 19,
wherein the multiple first configuration values are configured as a first set comprising multiple different configuration values, and
wherein the multiple second configuration values are configured as a second set comprising multiple different configuration values.
